(19) United States
(12) Patent Application Publication
(10) Pub. No.: US 2011/0306014 A1
(43) Pub. Date: Dec. 15, 2011

(54) Components, Systems and Related Methods for Temporary Prosthetics

(76) Inventors: Gregory J. Conte, Danville, CA (US); Roger S. Ranck, Ambler, PA (US)

(21) Appl. No.: 12/813,875

(22) Filed: Jun. 11, 2010

(51) Int. Cl. A61C 9/00; A61C 8/00

(52) U.S. Cl. 433/173; 433/214

(57) ABSTRACT

An impression coping may include an implant-engaging portion configured for engagement with a dental implant, and a coronal post comprising at least one impression feature configured for embedding in impression material and at least one retention feature configured to matingly engage a corresponding retention feature of a temporary restoration to secure the temporary restoration to the impression coping.

### TECHNICAL FIELD

The present teachings relate to components and systems used for making and placement of temporary prosthetics. In particular, the present teachings relate to components used to both take impressions and support a temporary prosthetic, for example, in various bone and/or cartilage implant procedures, such as, for example, dental implant procedures.

### BACKGROUND

Implants placed in bone and/or cartilage represent a growing field of reconstruction technology for replacing parts of the body, for example, with prosthetic parts. Such implants may be secured in the bone and/or cartilage and used to anchor a prosthetic body part in position. To facilitate making the prosthetic body part so as to ensure an accurate and aesthetically pleasing fit at the location of the implant, an impression of the implant implanted in the patient's body is typically taken to record the location and positioning of the implant, as well as parts of the body surrounding the implant.

One type of implant that has relatively widespread use includes dental implants. During dental implantation, a hole is drilled through the gingiva, the gums surrounding the root of a tooth, and/or into the jawbone. An implant, which may be, for example, made of titanium or titanium alloy, is then fixed within the hole of the jawbone. Over a period of months, the titanium implant fuses to the jawbone through a process called osseointegration. After a period of time, ranging from weeks to months, a permanent replacement tooth (sometimes referred to as a final restoration or permanent restoration) is secured relative to the implant in the patient's mouth. Prior to placement of the permanent replacement tooth, a temporary replacement tooth (sometimes referred to as a temporary restoration) may be secured relative to the implant to provide some function and aesthetics in the time period before the permanent replacement tooth is in place.

Dental implant systems and techniques for making and implanting permanent and temporary replacement teeth generally involve the use of several component parts and steps, which may vary depending on the procedure employed. To take an impression of the site of the implant for making the restoration, at least one approach involves positioning an impression coping relative to an implant fitted within the patient's mouth, embedding the impression coping in impression material to take an impression of the implant coronal end (i.e., the end which receives the restoration), any superstructure, such as, for example, an abutment, engaged with the implant, and the soft tissue and bone at the location of the implant, and transferring the so-formed impression and impression coping to an analog at a dental laboratory to produce a master cast by pouring modeling compound onto the impression. As those having ordinary skill in the art are familiar with, impression copings can be configured to either be removed from the mouth separately from the impression material once the impression is taken (referred to as a transfer impression coping) or remain embedded in the impression material and be removed therewith as the impression material is removed from the mouth (referred to as a pick-up impression coping). In either case, the impression coping is often disposed of after it is used in the dental laboratory to fabricate the permanent and/or temporary restoration.

If a temporary restoration is desired during the time period before which the permanent restoration is able to be secured relative to the implant, which can range from about 2 weeks to about 6 months depending on the case and position in the mouth, in some cases a temporary abutment may be placed relative to the implant and used as a support for the temporary restoration.

To improve upon current techniques for placing temporary prosthetic parts, it may be desirable to save cost and/or reduce the number of component parts involved with at least some implant procedures. It may also be desirable to provide a method of placing a temporary restoration that is relatively simple and quick, yet provides sufficient strength so as to withstand loading (e.g., occlusal loading) without damage during the time period in which a patient is awaiting a permanent restoration.

### SUMMARY

The present teachings may satisfy one or more of the above-mentioned desirable features and/or solve one or more of the above-mentioned problems. Other features and/or advantages may become apparent from the description that follows.

Various exemplary embodiments of the present teachings provide an impression coping that comprises an implant-engaging portion configured for engagement with a dental implant, and a coronal post comprising at least one impression feature having dimensions to permit embedment in impression material and at least one retention feature configured to matingly engage a corresponding retention feature of a temporary restoration to secure the temporary restoration to the impression coping.

Various exemplary embodiments of the present teachings provide a dental restoration system that includes an impression coping configured for engagement with a dental implant and comprising at least one impression feature configured for embedding in impression material and at least one retention feature. The system may further comprise a temporary restoration comprising at least one retention feature configured to matingly engage with the at least one retention feature on the impression coping to secure the temporary restoration to the impression coping.

Various exemplary embodiments of the present teachings provide a method of performing a dental restoration, the method comprising securing to a dental implant an impression coping that has been previously used to take an impression of the dental implant, and then securing a temporary restoration to the impression coping.

Various exemplary embodiments of the present teachings provide a method of performing a dental restoration that comprises securing a component comprising at least one impression feature to a dental implant implanted in a patient's mouth, embedding a portion of the component comprising the at least one impression feature in impression material to take an impression, removing the impression and the component from the patient's mouth, re-securing the component relative to the dental implant to support a temporary restoration relative to the dental implant.

In various exemplary embodiments, the present teachings provide a temporary coping comprising an inner surface comprising at least one retention feature configured to matingly engage with at least one corresponding retention feature of a support secured to an implant. The temporary coping further comprises at least one impression feature on an outer surface, the at least one impression feature being configured for embedding in impression material to take an impression of the implant, wherein the temporary coping is configured to be removed from mating engagement with the support under a pull-off force ranging from about 0.5 lb. to about 6 lb.

Additional objects and/or advantages of the present teachings will be set forth in part in the description which follows, and in part will be obvious from the description, or may be learned by practice of the present teachings. Those objects and advantages may be realized and attained by means of the elements and combinations particularly pointed out in the appended claims.

It is to be understood that both the foregoing general description and the following detailed description are exemplary and explanatory only and are not restrictive of the present teachings or claims. Rather, the claims are intended to cover a broad scope, including equivalents.

### BRIEF DESCRIPTION OF THE DRAWINGS

The accompanying drawings, which are incorporated in and constitute a part of this specification, illustrate exemplary embodiments and together with the description, serve to explain certain principles. In the drawings,

FIG. 1 is a perspective view of an exemplary embodiment of an impression coping in accordance with the present teachings;

FIG. 2 is a side view of the impression coping of FIG. 1;

FIG. 3 is a another side view of the impression coping of FIG. 1 with internal features of the impression coping shown in dotted line;

FIG. 4 is a cross-sectional view of the impression coping taken through line 4-4 in FIG. 3;

FIG. 5 is a perspective view of an exemplary embodiment of a screw for securing the impression coping of FIG. 1 relative to a dental implant in accordance with the present teachings;

FIG. 6 is a cross-sectional view of the screw of FIG. 5 inserted in the impression coping of FIG. 1;

FIG. 7 is a perspective view of an exemplary embodiment of a temporary coping in accordance with the present teachings;

FIG. 8 is an apical end view of the temporary coping of FIG. 7;

FIG. 9 is a cross-sectional view of the temporary coping of FIG. 7 taken through line 9-9 of FIG. 8;

FIG. 10 is a cross-sectional view of the temporary coping of FIG. 7 taken through line 10-10 of FIG. 8;

FIG. 11 is an apical end view, similar to the view of FIG. 8, of another exemplary embodiment of a temporary coping in accordance with the present teachings;

FIG. 12 is a view of the temporary coping of FIG. 7 in mating engagement with the impression coping of FIG. 1, with the temporary coping shown in cross-section and shown supporting the tooth veneer;

FIG. 13 is a view of the impression coping of FIG. 1 in mating engagement with an exemplary embodiment of an implant in accordance with the present teachings;

FIG. 14 is a view of an exemplary embodiment of a temporary restoration in mating engagement with the impression coping of FIG. 1; and

FIG. 15 is a cross-sectional view of another exemplary embodiment of a temporary coping.

### DETAILED DESCRIPTION

Reference will now be made in detail to various exemplary embodiments, examples of which are illustrated in the accompanying drawings. Wherever possible, the same reference numbers will be used throughout the drawings to refer to the same or like parts.

As used herein, those having ordinary skill in the art are familiar with the meaning of the terms “apical” and “coronal.” As used herein, “apical” refers to a direction toward the jaw bone, or toward root tips of teeth. If the term “apical” is used to refer to a portion of a component, it refers to the portion of the component that would be facing, closer to, and/or in a direction of the jaw bone and/or root tips if the component were placed in an operational position in a patient's mouth. The term “coronal” refers to a direction opposite the jaw bone and toward the crowns of teeth. If the term “coronal” is used to refer to a portion of a component, it may refer to the portion of the component that would be facing, closer to, and/or in direction of the crown portion of teeth if the component were placed in an operational position in a patient's mouth.

In accordance with various exemplary embodiments, the present teachings contemplate impression copings that are configured to be used to take an impression of an implant implanted in a patient's body and, after use at a laboratory or otherwise for restoration fabrication (whether permanent or temporary), can be used again as a supporting structure to support a temporary restoration relative to the implant. Reusable impression copings in accordance with the present teachings may save cost and/or reduce the number of component parts involved with some prosthetic implant procedures. In various exemplary embodiments, impression copings in accordance with the present teachings may be configured to be secured to a dental implant to take an impression of the implant and also, like an abutment, to support a temporary restoration relative to the implant. In various exemplary embodiments, impression copings of the present teachings may be configured to be secured to dental implants having an opening in a coronal end thereof and internal threading configured to receive a screw to secure the impression coping to the dental implant. Anti-rotational features may be provided in order to prevent rotation of the impression coping relative to the implant when the impression coping is secured thereto. For example, the impression coping may have an indexed, for example, polygonal-shaped, and/or tapered (e.g., via a Morse taper) apical end portion (e.g., boss or recess) configured to mate with a corresponding shaped coronal end portion (e.g., boss or recess) of a dental implant.

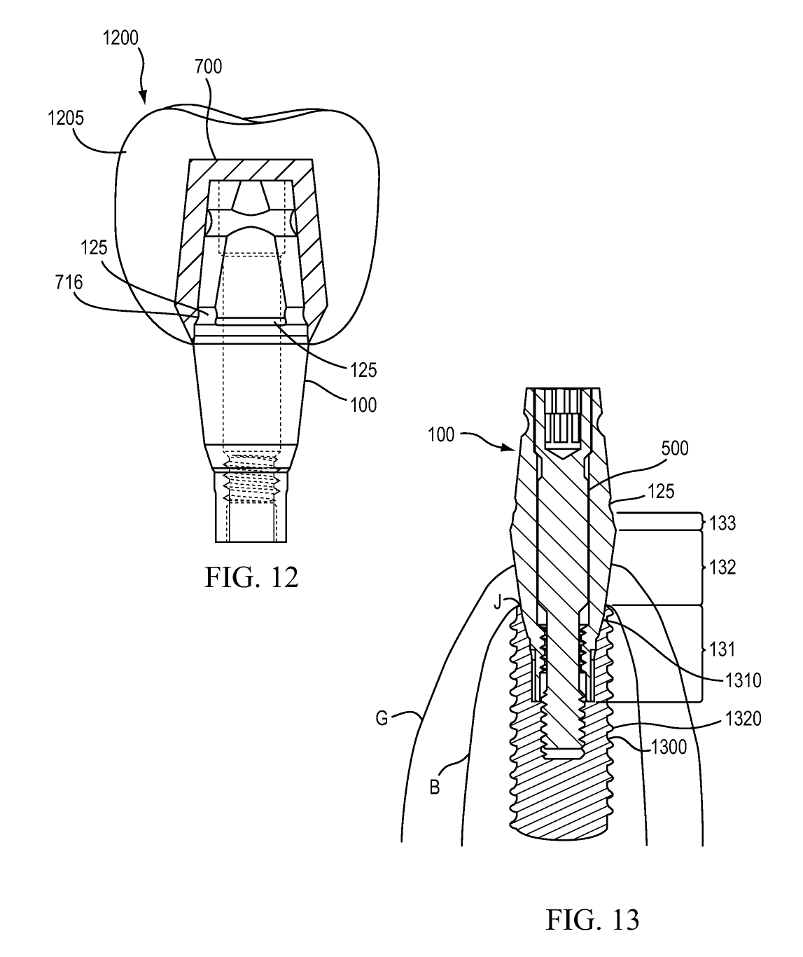

Impression copings in accordance with various exemplary embodiments may be configured to engage in a non- or anti-rotational manner with a variety of dental implant configurations, including, but not limited to, for example, submerged implants, bone-level implants, and tissue-level implants. By way of non-limiting example only, in at least one exemplary embodiment, as illustrated in FIG. 13, an impression coping may be configured to be secured relative to Straumann® Bone Level implants and the apical end portion of the impression coping may be configured for mating engagement with the Straumann CorssFit™ Connection (an exemplary implant 1300 having such a configuration is depicted in FIG. 13). However, those having ordinary skill in the art will understand that modifications may be made to the impression coping configurations herein in order to achieve a secure fit and use with various implant configurations, such as conventional implant configurations that include but are not limited to, for example, various implants by Straumann; Nobel Biocare; Keystone; BlueSkyBio; 3I; and Zimmer, among others. Further, impression copings in accordance with the present teachings may be modified as necessary to fit with implants having any of a variety of coronal end (e.g. coronal seat or coronal neck configurations) configurations, including, but not limited to, for example, tapered internal coronal necks (e.g., conically-tapered internal coronal necks) and/or indexed (e.g., polygonal) or lobed (e.g. tri-lobed) anti-rotational internal coronal neck features, with which those having ordinary skill in the art are familiar. Those having ordinary skill in the art will appreciate a wide variety of conventional implants and other implant structures with which the various components in accordance with the present teachings may be utilized.

Although various exemplary embodiments include screw-retained impression copings, it is envisioned as within the scope of the present teachings that the impression copings may be secured to dental implants in numerous ways configured to provide sufficient strength to prevent the impression coping from being loosened from the dental implant, particularly during either taking an impression or occlusal loading when the impression coping is serving as a supporting structure for a temporary restoration. The mechanism for securing the impression coping relative to the dental implant may also be configured so as to minimize the risk of damage occurring to either the implant, the impression coping, and/or the temporary restoration. For example, screw threading may be provided directly on the impression coping itself, such as for example, by a post extending from the impression coping at the apical end, and be configured to mate with corresponding screw threading on a dental implant. Those having ordinary skill in the art will appreciate that the securing connection mechanism between the impression coping and the implant can take on a variety of configurations that may depend on the implant configuration for which it is desired to use the impression coping. By way of non-limiting example, impression copings in accordance with various exemplary embodiments may be configured to engage and be secured to the implant via a snap-fit retention, a friction fit retention (for example, using a Morse taper type of configuration), or a combination thereof.

In various exemplary embodiments, a coping may serve as both an impression coping and a temporary coping to which veneering material may be applied to form a temporary restoration. In one exemplary embodiment, such a coping may be configured to be engaged with a support, such as, for example, an abutment, attached to the dental implant. The coping may be engaged with the support to take the impression of the implant and then, after use for forming a restoration based on the impression, may be re-secured to the support and implant as a temporary restoration. In other words, a temporary restoration may be formed by applying veneering material to the coping and may be secured to an implant in the patient's mouth, for example, via engagement with a support, such as an abutment, for example.

In various exemplary embodiments, the present teachings contemplate impression copings configured to be used as transfer impression copings, for example, using a closed tray impression technique known to those ordinarily skilled in the art. In such a technique, after the impression coping in the patient's mouth is embedded in the impression material, the impression coping remains in the patient's mouth when the impression material is removed, pulling the impression coping out of the socket formed around it in the impression material. The impression coping is then removed separately from the patient's mouth and reinserted into the hardened or semi-hardened impression to form the mold for a restoration.

Those having ordinary skill in the art would understand that impression copings in accordance with exemplary embodiments of the present teachings may also be configured for use as pick-up impression copings, for example, using an open tray impression technique, wherein the impression coping is picked up with the impression as the impression material is removed from the patient's mouth. Generally, such pick-up impression copings require more defined surface profiles and features on their coronal posts that allow for the impression coping to remain in the impression material during removal from the patient's mouth. When such pick-up impression copings are used, it may be desirable to modify the interior configuration of the temporary restoration or temporary restoration coping supported thereon to provide an enhanced mating with the coronal post of the impression coping.

In various exemplary embodiments, impression copings in accordance with the present teachings may have one or more retention features configured to provide a secure mating engagement of a temporary restoration on the impression coping. The one or more retention features on the impression coping may be configured to be complimentary to one or more corresponding retention features on a temporary restoration to provide a secure mating engagement, such as, for example, a snap-fit engagement, to retain the temporary restoration on the impression coping. In various exemplary embodiments, the one or more retention features on the impression coping may include one or more recesses (e.g., grooves) or protrusions extending at least partially circumferentially around an outer surface of the impression coping. The retention feature may be located on a coronal post of the impression coping that is configured to receive the temporary restoration. The one or more retention features may be disposed close to an end of the coronal post closest to the implant so as to provide good stability for the temporary restoration. In various exemplary embodiments, the finish line of a temporary restoration secured to the impression coping may be on the impression coping at an axial location slightly apical to the axial location of the retention feature.

Although a variety of materials can be used to make impression copings in accordance with the present teachings, it may be desirable to use a material that exhibits sufficient yield strength to endure the impact of chewing forces (for example, a yield strength of greater than about 100 ksi (one thousand pounds per square inch), including repeated chewing forces over time. Further, it may be desirable to use a radiographic material capable of being observed via X-ray so as to be able to take an X-ray of the patient's mouth during the impression process. Another desirable attribute when selecting a material for the impression copings in accordance with the present teachings is a material that can have a cream or white color so as to minimize the possibility of seeing the impression coping underneath the outer veneer material when the temporary restoration is in place in the patient's mouth.

In various exemplary embodiments, the impression copings described herein may be made of carbon fiber, or of a metal or a metal alloy, such as a biocompatible medical grade metal, for example, stainless steel, titanium, and/or titanium alloy. Other suitable materials also may be used, including, for example, a material chosen from bis-acrylic or a bis-acrylic composite, also known as a bis-acrylic hybrid. In at least one embodiment of the present disclosure, the bis-acrylic or bis-acrylic composite may comprise ProTemp™ Plus Temporization Material available from 3M ESPE. Other nonlimiting examples of suitable bis-acrylic composites that impression copings according to the present teachings may be made from include, but are not limited to, for example, Luxatemp®, a composite of bis-acrylic, glass powder, and silica, available from DMG; InstaTemp® Max, a composite of bis-acrylic, glass powder, and silica, available from Sterngold Dental; Structur Premium, Acytemp, Integrity Fluorescence, and Kanitemp Royal.

In at least one exemplary embodiment of the present disclosure, impression copings may be made of a material having a material toughness (i.e., fracture work) of at least about 10.0 KJ/m² (Kilo-Joules per square meter). The material toughness is a measure of the amount of energy that may be absorbed by the material before it fractures, and may be measured by any method known to those of skill in the art. In at least one exemplary embodiment of the present disclosure, the impression coping may be made of a material having a fracture toughness of at least about 1.0 Mpa*m^{1/2}(Mega-Pascal-meter^{1/2}). In at least one further embodiment, impression copings in accordance with the present teachings may be made a material capable of forming a chemical bond with a restorative tooth and having a fracture toughness of at least 1.5 MPa*m^{1/2}, such as at least 2.0 MPa*m^{1/2}. The fracture toughness is a measure of a material's resistance to crack propagation when a crack is present, and may be measured by any method known to those of skill in the art.

Impression copings in accordance with at least one exemplary embodiment of the present disclosure may be made of a material having a compressive strength of at least about 350 MPa. In at least one further embodiment, the material may have a compressive strength of at least about 375 MPa. The compressive strength is a measure of a material's resistance to compression, and may be measured by any method known to those of skill in the art.

Depending on the materials used to form the impression coping, impression copings may be either machined or molded, for example, injection-molded. By way of example, impression copings made of metal materials may be machined and impression copings made of plastics, such as bis-acrylic or bis-acrylic composites, may be molded.

In various exemplary embodiments, impression copings in accordance with the present teachings may be configured to receive temporary restorations that comprise temporary copings including one or more retention features configured to provide a secure mating engagement, such as a snap-fit engagement, with the one or more corresponding retention features on the impression coping. Temporary copings in accordance with various exemplary embodiments may be made of a variety of materials, including, for example, plastics, metals, and/or metal alloys. In an exemplary embodiment, a temporary coping in accordance with the present teachings may comprise a material configured to provide a chemical bond with veneering material used for the outer, aesthetic portion of the temporary restoration while also providing sufficient strength to withstand occlusal loads. A suitable material may include, for example, a bis-acrylic material, such as, for example, Protemp™ Plus Temporization Material made by 3M ESPE.

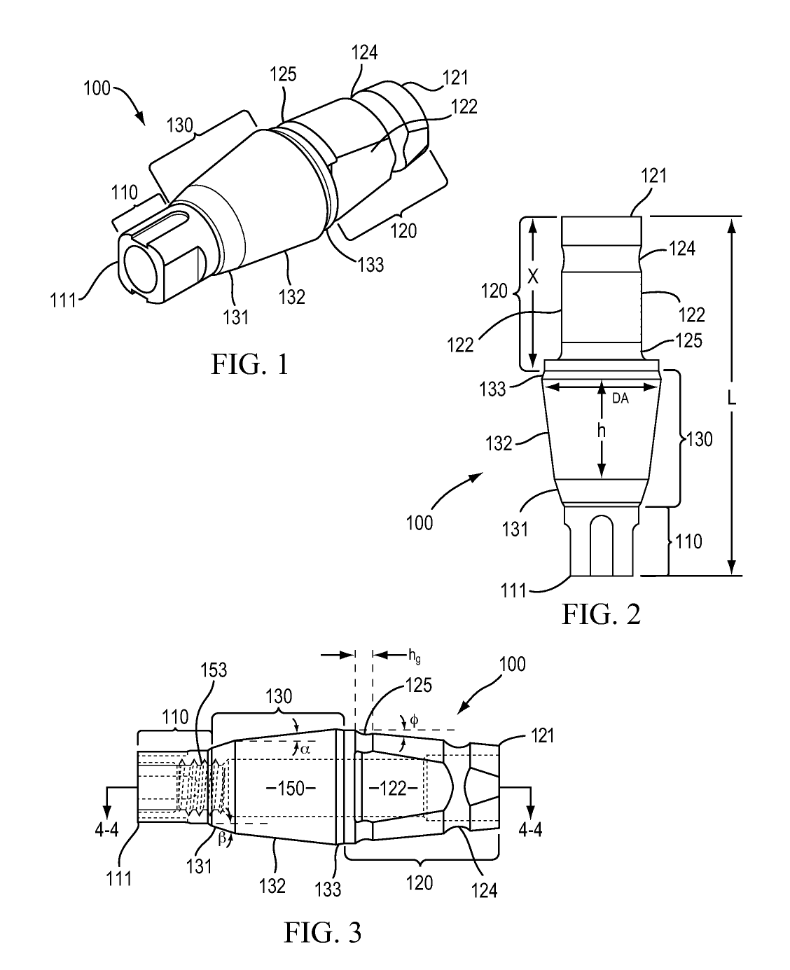

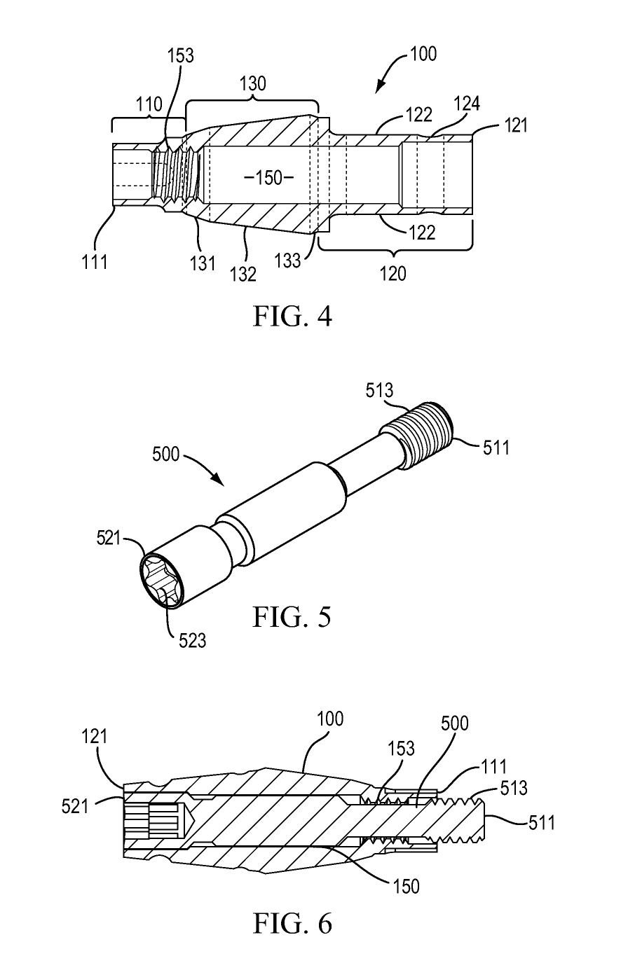

With reference now to FIGS. 1-4, an impression coping in accordance with an exemplary embodiment of the present teachings is illustrated. The impression coping 100 includes an implant-engaging post 110 configured to securely engage with an implant (such as, for example, implant 1300 shown in FIG. 13) and a coronal post 120 configured to be embedded in impression material when used to take an impression. The coronal post 120 also is configured to receive and support a temporary restoration, as will be set forth in more detail below. As shown best in FIGS. 3 and 4, the impression coping 100 may define a passage 150 extending from an opening in an apical end 111 to an opening in a coronal end 121 of the impression coping 100. The passage 150 may be configured to receive a screw to secure the impression coping 100 to an implant. The screw may be accessed via a tool through the opening in the coronal end 121 to advance the screw along the length of the impression coping 100 and into engagement with an implant.

Disposed between the implant-engaging post 110 and the coronal post 120 is a substantially frustro-conical portion 130. The frustro-conical portion 130 is configured to mate with a correspondingly tapered internal surface of the implant 1300 shown in FIG. 13 and emerge from the implant 1300 and through the gum tissue G, for example from about 1 mm to about 2 mm above the gum tissue G. In the embodiment illustrated, the frustro-conical portion 130 has three regions 131, 132, and 133 and a peripheral outer surface that tapers by varying degrees in each of those regions. The majority of the frustro-conical portion 130 may be defined by region 132 having an angle of taper α (see FIG. 3), with the direction of taper being inward toward the apical end 111 of the impression coping 100. The region 132 may be widest (e.g., have its largest diameter) where it meets a small chamfered region 133 that tapers slightly inwardly from the region 132 to meet with the coronal post 120. The chamfered region 133 (sometimes referred to as a feathered margin by those ordinarily skilled in the art) provides a finish line and a “shelf” to support a temporary restoration supported on the coronal post 120. In at least one exemplary embodiment, the chamfered region 133 is less than or equal to about 5 mm from the apical end 111 of the coping 100.

At the end where the frustro-conical portion 130 meets the implant-engaging post 110 is another region 131 that tapers inwardly from the end of region 132 to the implant-engaging post 110 at an angle β (see FIG. 3) that is slightly greater than the angle α. In various exemplary embodiments, β may range from about 3° to about 25°, for example, from about 10° to about 20°. For example, β may be about 15°. The region 131 of the exemplary embodiment illustrated mates with and can be received in the coronal opening 1310 of the implant 1300 shown in FIG. 13. Accordingly, the dimensions and taper of the region 131 are selected to provide a mating fit with the coronal opening 1310 (sometimes referred to as a coronal seat), as illustrated in FIG. 13. Providing such a taper, the angle of which may substantially correspond to the taper angle of an internal surface portion at the coronal seat region of the implant with which the impression coping mates, may provide a substantially flush mating engagement between the impression coping and the implant, which may enhance the accuracy of the fit and proper seating of the impression coping on the implant. In various exemplary embodiments, the region 131 may be configured similar to a Morse taper (although it may have a different taper angle), which may render the impression coping 100 non-rotational under occlusal load once seated in the implant coronal opening. In other words, it may take more force to unscrew the impression coping to loosen it than to secure it to the implant.

As explained above, the implant-engaging post 110 and at least a lower part of frustro-conical portion 130 may be configured to engage with a coronal seat region on an implant as those ordinarily skilled in the art are familiar with. Thus, depending on the implant configuration with which the coping is to engage, the implant-engaging post 110 and frustro-conical portion 130 may have a variety of configurations. As discussed above, by way of example, the post 110 and the region 130 may be configured to engage with an internal region of implants commercially available by Straumann® that provide a so-called CrossFit™ Connection. As shown in FIG. 13, the impression coping 100 can be placed within the seat region of the implant 1300 by dropping the impression coping 100 into the coronal opening 1310 in the implant 1300 and a retaining screw 500, described in further detail below, may be torqued down to secure the impression coping 100 to the implant 1300. The juncture J of the implant 1300 and the impression coping 100 is located substantially where regions 131 and 132 meet, such that region 132 emerges from the coronal seat region of the implant 1300 to form an emergence cuff (sometimes referred to as a gingival cuff by those ordinarily skilled in the art).

Referring again to FIGS. 1-4, in various exemplary embodiments, therefore, the peripheral surface of the frustro-conical portion region 132 is configured to provide an emerging portion of the coping 100 from the coronal seat region of an implant that receives the impression coping 100 and extending some distance above the gumline. In various exemplary embodiments, the angle α of the frustro-conical portion region 132 may range from about 1.5° to about 15°, for example, about 5° to about 10°. For example, a may be about 1.5°, about 5.8°, about 8°, about 11° or about 15°, respectively. In various exemplary embodiments, the length h of the portion 132 from the region 131 to the region 133 may range from about 0.5 mm (0.0197 in.) to about 6 mm (0.236 in.), for example, from about 1 mm (0.0394 in.) to about 4 mm (0.157 in.). Also, in various exemplary embodiments, the diameter D_{A} at the widest portion of the impression coping 100 may range from about 2.5 mm (0.0984 in.) to about 7 mm (0.276 in.), for example, from about 3 mm (0.118 in.) to about 6.5 mm (0.256 in.). The length h of region 132 may vary based on the diameter D_{A} and the angle α.

As mentioned above, the frustro-conical portion 130 includes at its coronal end a chamfered region 133 that serves as a shelf to support and provide a finish line for a temporary restoration, for example, for a temporary coping associated with the temporary restoration as depicted in the exemplary embodiment of FIG. 12. The region 133 may taper inwardly toward the coronal end 121 at an angle ranging from about 30° to about 60°, for example, about 45°, measured from the longitudinal axis of the impression coping 100. The impression coping 100 may be widest at region 133, having a diameter D_{A} as mentioned above. Supporting the temporary restoration at region 133 may help to minimize a risk of fracturing the temporary restoration by transferring forces to region 132 and the remainder of the impression coping 100 and also relieving pressure exerted on a screw retaining the impression coping 100 in an implant. The dimensions of the region 133 along the longitudinal axis of the impression coping 100 may be selected so as to mate with an end region of a temporary coping.

As is also depicted in the exemplary embodiment of FIGS. 1-4, the coronal post 120 may extend roughly about ½ (or just less than ½) of the overall length L of the impression coping 100. The outer peripheral surface of the coronal post 120 may also generally taper inwardly at an angle φ (see FIG. 3) toward the end 121. In various exemplary embodiments, the coronal post 120 may taper at an angle, φ, ranging for example, from about 4° to about 8°, for example, from about 5° to about 6.5°, for example, the angle φ may be about 6°. In various exemplary embodiments, the length X (see FIG. 2) of the coronal post 120 may range from about 3 mm (0.118 in.) to about 8 mm (0.315 in.), for example, from about 4 mm (0.157 in.) to about 7 mm (0.276 in.).

One or more surface features may be provided on the coronal post 120 to facilitate taking an impression of the impression coping 100 by providing one or more features configured to permit embedding of the impression material around the coronal post 120. Those having ordinary skill in the art are familiar with various such surface features that may be provided on a coronal post of an impression coping to enhance embedment of the impression coping in the impression material and/or to facilitate registering the location and position of the impression coping in the patient's mouth. In the exemplary embodiment of FIGS. 1-4, the surface features of the coronal post 120 include two opposing flat surface portions 122 and a relatively deep circumferential recess or indentation 124 disposed proximate the coronal end 121. Other surface features, such as, for example, serrations, knurled surfaces, holes, ridges, etc. in addition to or in lieu of the flat surface portions 122 and recess 124 may be provided without departing from the scope of the present teachings. Those having ordinary skill in the art are familiar with various surface features on impression copings to provide sufficient embedment in an impression material, for example, to substantially prevent vertical, lateral, and/or rotational relative movement, and to indicate an orientation of the impression coping secured to the implant.

In at least one exemplary embodiment, the recess 124 may be configured to permit an impression cap (not shown) or other element to be snap-fit thereto to permit an impression to be taken. After the impression is taken, the cap or other element may be picked up with the impression material and lifted off and out of engagement with the impression coping 100, in a manner with which those ordinarily skilled are familiar with. The impression coping may then be unscrewed from the implant and used, if needed, to form temporary and/or permanent restorations. Then, in accordance with the present disclosure, the impression coping may be reused as an abutment to support a temporary restoration.

In various exemplary embodiments, the recess 124 may have a depth ranging from about 0.006 in. to about 0.010 in. and a height along the axial length of the impression coping ranging from about 0.368 in. to about 0.400 in. In one exemplary embodiment, the one or more surface features on the coronal post of the impression coping may be configured such that the impression can be removed from the impression coping while the impression coping remains in the patient's mouth; in other words, the surface features may be configured to permit a closed-tray, transfer-type of impression technique. The retention groove 124 may be formed deep enough so as to substantially prevent or minimize vertical, lateral and/or rotational movement while the impression is being taken or a model (e.g., stone model) is being formed. Moreover, the flat surface portions 122 may register in the impression material the positioning (e.g., orientation) of the impression coping 100 within the patient's mouth and may substantially eliminate or minimize rotational movement in impression while the impression is being taken or the model is formed in the dental laboratory.

Other designs of the impression coping are also considered within the scope of the present teachings. For example, coronal post 120 may be configured (e.g., have a surface profile and/or surface features) that permits the impression coping to be used for a pick-up, open tray type of impression technique. Those having ordinary skill in the art would understand how to modify the coronal post of the impression coping to configure the impression coping for use in a pick-up, open tray type of impression technique.

Aside from enhancing embedment and registering the position of the impression coping, one or both of the flat surface portions 122 also can assist in preventing relative rotation between the coronal post 120 and a temporary restoration supported on the coronal post 120. Those having ordinary skill in the art are familiar with such so-called “flats” used on the component supporting posts of various dental implant components, such as, for example, abutments. The flat surface portions 122 may extend along a substantial length of the coronal post 120, however, virtually any length may suffice that is sufficient to provide adequate registration in the impression material. Further, although two opposing flat surface portions are depicted in the exemplary embodiment of FIGS. 1-4, those having ordinary skill in the art would understand that any number of flat surface portions ranging from 1 to more than 1, for example, 2, 3, 4, etc., may be used as desired without deviating from the scope of the present teachings; likewise relative positioning of the flat surface portions may be altered as desired.

Around the outer peripheral surface of the coronal post 120 proximate the frustro-conical portion 130, one or more retention features may be provided that are configured to engage with one or more cooperating retention features on a temporary restoration to achieve a mechanical retention (e.g., via a snap-fit engagement) of the temporary restoration on the impression coping 100, as described in further detail below. In various exemplary embodiments, the one or more retention features may be positioned at one or more locations around the outer peripheral surface of the coronal post 120, for example, at substantially the same axial position along the coping 100.

More specifically, in the exemplary embodiment of the impression coping 100 shown in FIGS. 1-4, the coronal post 120 is provided with a retention feature in the form of a recess (or groove) 125 positioned just coronal to the widest cross-sectional portion (at D_{A} in FIG. 2) of the impression coping 100 and extending circumferentially around post 120, including the flat surface portions 122. On the flat surface portions 122, the groove 125 is only about half the height of the remaining portions of the groove 125. In various exemplary embodiments, one or more retention grooves, such as, for example, the retention groove 125, may be positioned along a length of the portion 120 that is located from about 2 mm to about 3 mm above a coronal end portion of an implant in the coronal direction when the impression coping 100 is in engagement with the implant and fully inserted in the implant in an operational position. In the exemplary embodiment of FIG. 13, therefore, the retention groove 125 may be about 2 mm (0.079 in.) to about 3 mm (0.118 in.) from the juncture J where the implant 1300 meets the impression coping 100. For example, in the exemplary embodiment of FIG. 2, the retention groove 125 may be positioned about midway to two-thirds along the length L (see FIG. 2) of the impression coping 100 from the apical end 111. For example, the retention groove 125 may be about 2 mm to about 3 mm from where regions 131 and 132 meet.

In various exemplary embodiments, the retention groove 125 may have a radiused surface profile. The surface of the retention groove 125 may, for example, define a radius of curvature ranging from about 0.010 in. to about 0.030 in. In various exemplary embodiments, a retention groove may have a height h_{g} (see FIG. 3) (measured along the longitudinal axis of the impression coping 100) ranging from about 0.015 in. to about 0.250 in., for example, about 0.021 in. In an exemplary embodiment, the retention groove 125 may be machined to a depth ranging from about 0.001 in. to about 0.005 in., for example, 0.003 in.

In various exemplary embodiments, the flat surface portions 122 may be about 0.03 in. to about 0.065 in. from the centerline of the impression coping 100. That distance may vary and be selected, however, depending on the size, for example, of the diameter of the coronal post 120. For example, the distance of the flat surface portions 120 to the centerline of the impression coping 100 may be about 65% to about 80%, for example, about 72%, of the radius at the corresponding axial location of the coronal post 120.

Although the exemplary embodiment of FIGS. 1-4 depicts a single retention groove 125 (the height of which may alter depending upon whether it is formed on one of the flat surface portions 122 or not) extending circumferentially around the periphery of the post 120, those having ordinary skill in the art will appreciate that any number of retention grooves, for example, separated by one or more non-grooved portions also may be provided around the outer peripheral surface of the post 120 but substantially at the same axial location along the length of the impression coping 100. For example, two grooves may be provided in the exemplary embodiment of FIGS. 1-4 extending substantially between the flat surface portions 122, but not being cut into the flat surface portions 122. The grooves may be disposed at locations so as to enable one or more cooperating protrusions on a temporary restoration (e.g., on a temporary coping part of a temporary restoration) to engage in a snap-fit manner therewith. Moreover, retention grooves in accordance with various exemplary embodiments, rather than extending around all or a portion of the outer peripheral surface to have an arc-like shape, could provide a localized indented or recessed configuration configured to engage with one or more localized protrusion features (e.g., like bumps) on a temporary restoration to provide a snap-fit engagement between the impression coping and the temporary restoration.

Although in the exemplary embodiment illustrated in FIGS. 1-4, the retention grooves have a substantially radiused surface profile, such a surface profile configuration is exemplary only and the grooves could have a variety of configurations such as angled with two or more sides so as to engage a variety of different protrusion surface profiles, including, for example, triangular-, square-, rectangular-, and other polygonal-shaped protrusion surface profiles.

In various exemplary embodiments, the one or more retention features provided on the outer peripheral surface of the impression coping may be positioned so as to be accessible just above, at, or just below the gumline, when the impression coping is positioned in place relative to an implant in a patient's mouth. For example, with reference to FIG. 13, the gumline G is depicted for a bone level implant 1300 (set in bone B) to which the impression coping 100 is secured. Such positioning of the retention feature(s) may facilitate engagement of a cooperating retention feature on a temporary restoration, for example, making it easier to push the gum tissue out of the way during engagement and/or by making it easier to receive a sensation (such as, for example, tactile and/or auditory) confirming a snap-fit engagement between the cooperating retention features of the impression coping and the temporary restoration. Placement closer to the gum tissue margin may enhance the stability of the temporary restoration on the impression coping by providing retention at a relatively wide portion of the impression coping that presents a larger retention surface area (e.g., the retention groove(s) or protrusion(s) may present a relatively large surface area when placed close or at the widest portion of the impression coping). Likewise, in cases where bonding, for example, by cement or other adhesive, of a temporary restoration to the impression coping may be desired, a greater surface area on the wider portion of the impression coping may promote a more stable bonding. For impression copings configured to be situated at or below the gumline (tissue margin), it may be desirable (although not necessary) to position the one or more retention features somewhat closer to the coronal end of the impression coping than the retention feature 125 is disposed in the exemplary embodiment of FIGS. 1-4 in order to position the retention feature 125 just at or above the tissue margin.

In accordance with various exemplary embodiments, the coronal post 120 may have a length ranging from about 4 mm (0.157 in.) to about 7 mm (0.276 in.), for example, about 4 mm, about 5.5 mm (0.216 in.) or about 7 mm (0.276 in.). Likewise, impression copings in accordance with various exemplary embodiments of the present teachings may have various dimensions where the impression coping 100 mates with an implant so as to be configured to mate with implants having various coronal seat configurations, including various coronal neck outer diameters, such as, for example, coronal neck outer diameters of about 2.7 mm (0.106 in.), about 3.3 mm (0.13 in.), about 4.1 mm (0.161 in.), about 4.8 mm (0.189 in.), about 6.5 mm (0.256 in.), or about 7 mm (0.276 in.).

Those having ordinary skill in the art would understand, however, that the dimensions of impression copings and corresponding portions thereof may be modified in accordance with the present teachings in order to fit with various implant configurations and/or temporary restoration and temporary coping configurations, and/or as desired to satisfy a particular patient and/or need; the dimensions set forth herein are non-limiting and exemplary only. For example, those ordinarily skilled in the art would appreciate a variety of impression coping dimensions selected so as to mate with a variety of implant configurations, with which those having ordinary skill in the art are familiar.

In an exemplary embodiment, the impression coping 100 may be machined in order to provide precise tolerances of the various features, including, for example, the one or more retention features, tapered portions, impression recess, flat surface portions etc., so as to ensure an accurate and precise fit with the implant and/or other components, such as a temporary restoration or temporary coping thereof, configured to be secured to the impression coping. In an exemplary embodiment, the impression coping 100 may be made from cold-worked, commercially pure, Grade 4 titanium or other medical grade titanium or titanium alloy. However, any biocompatible material providing sufficient strength and durability, such as, for example, a variety of biocompatible titanium or stainless steel materials, may be used in accordance with various exemplary embodiments of the present teachings. Although using a radiopaque material for the impression coping may provide sufficient strength, for example to withstand occlusal loads, as well as permitting X-ray observation, other materials also may be suitable, including, for example, composites comprising ceramic and zirconium, composites comprising titanium and zirconium, and other zirconium composites or alloys.

As discussed above, one way in which to secure the impression coping to an implant is via a screw. With reference now to FIG. 5, one exemplary embodiment of a screw that may be used to secure the impression coping 100 to an implant is illustrated. As shown, the screw 500 has an apical end 511 and a coronal end 521. A region including the apical end 511 includes screw-threading 513 on an exterior surface thereof configured to engage with corresponding screw-threading on an internal surface of an implant with which the impression coping 100 is configured to engage, in a manner known to those ordinarily skilled in the art. The passage 150 of the impression coping 100 also includes screw threading 153 (see FIG. 3) configured for threaded engagement with the screw threading 513 to provide a controlled advancement of the screw 500 through the passage 150. The internal dimensions of the passage 150, including the screw threaded portion 153, and the external dimensions of screw 500 are selected to provide a secure, mating engagement between the screw 500 and the impression coping 100 to minimize or substantially prevent lateral movement of the screw 500 relative to the impression coping 100.

With reference to FIG. 6, when the screw 500 is fully advanced along the passage 150 of the impression coping 100, the screw threading 513 on the screw extends beyond the apical end 111 of the impression coping 100 to enable it to engage with the internal screw threading of an implant to secure the impression coping 100 thereto. The coronal end 521 of the screw 500 lies substantially flush with the coronal end 121 of the impression coping 100 in the position of FIG. 6. The coronal end 521 may be configured to engage with a tool for torquing the screw 500 to secure the impression coping 100 to the implant. In the exemplary embodiment of FIG. 5, the screw 500 defines a hexalobular profiled recess 523 in the coronal end 521 configured for engagement with a hex tool with which those ordinarily skilled in the art are familiar. Of course, those having ordinary skill in the art will appreciate that features other than the hexalobular opening 523 may be provided on the screw 500 to engage with any number of tools designed to torque the screw 500, and the hexalobular feature should be understood as nonlimiting and exemplary only.

By way of example, the screw 500 may be configured to be torqued in a range from about 25 Newton-centimeters (N-cm) to about 50 N-cm, for example, about 30 N-cm to about 35 N-cm, either by hand or via a power tool. Moreover, the screw 500 may be torqued via a screwdriver received in the recess 523, such as, for example by a standard 0.048 in. or 0.035 in. hex screwdriver, 4-lobe, or a standard torx, and the recess may be configured accordingly to receive such tools.

Those having ordinary skill in the art would understand that various other mechanisms may be utilized in lieu of or in addition to a screw-retained mechanism for securing the impression coping with a dental implant. For example, as described above, screw threading could be provided on the impression coping itself (e.g. on an external apical end portion thereof) and/or a variety of other engagement mechanisms on the apical post may be utilized. By way of example, whether in combination with a screw for retaining the impression coping or not, the impression coping apical post may provide an anti-rotational and secure engagement of the impression coping with the implant, for example, by being tapered and configured to fit within a similarly tapered opening in the implant, by having a lateral surface that is polygonal in cross-section (e.g., hexagonal or octagonal) and configured to fit within a similarly configured opening in the implant, and/or by incorporating snap- or interference-fit retention features configured to engage with corresponding retention features on the implant, or combinations thereof. Those ordinarily skilled in the art would be familiar with various types of engagement mechanisms that could be used to secure the impression coping to the implant, including, for example various internal or external polygonal and anti-rotational surfaces, tapered surfaces, lobed channels, and/or combinations thereof. The type of engagement mechanism selected may depend on the type of implant with which the impression coping is to be engaged. As mentioned above, as in the exemplary embodiment of FIGS. 1-4, impression copings in accordance with the present teachings may also be configured to engage with the Strauman CrossFit™ Connection.

Suitable materials from which the screw 500 can be made include, but are not limited to, various hard plastics, stainless steel, titanium, and/or alloys of stainless steel and titanium.

As discussed above, once the impression coping 100 is used to take an impression of the patient's mouth and a make corresponding mold for fabrication of a restoration, in accordance with the present teachings, the impression coping 100 may be cleaned and sterilized, if needed, to remove the impression material and then secured again to the implant to be reused as a support for a temporary restoration in the patient's mouth. In accordance with at least one exemplary embodiment, a temporary restoration may comprise a temporary coping configured for engagement with the coronal post 120 of the impression coping 100. In particular, the temporary coping may be provided with one or more retention features on an internal surface thereof configured to matingly engage, for example, in a snap-fit manner, to the one or more retention features 125 on the impression coping.

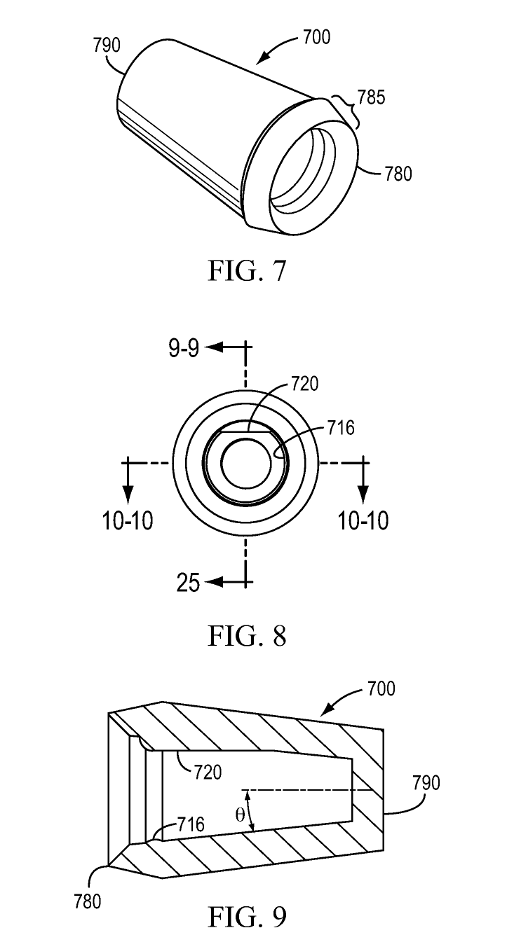

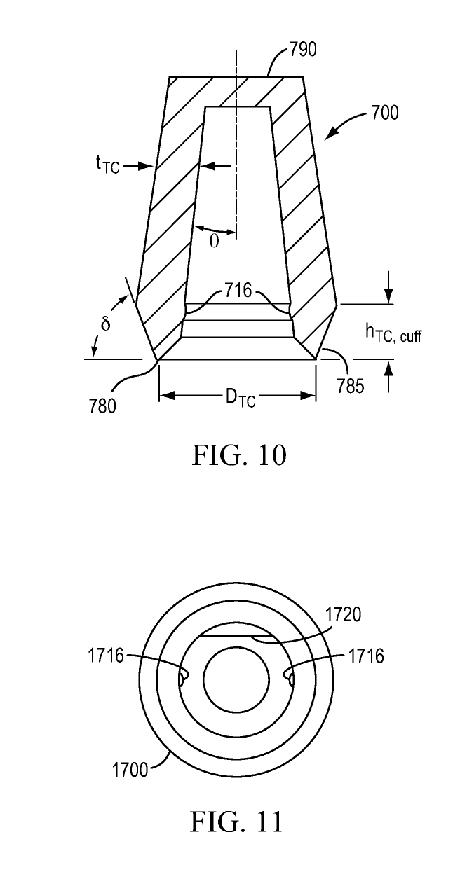

Referring now to FIGS. 7-11, various exemplary embodiments of temporary copings in accordance with the present teachings are illustrated. In FIGS. 7-10, the temporary coping 700 has a tapered, substantially frustro-conical, hollow configuration having an open apical end 780 and a closed coronal end 790. The temporary coping 700 may be configured to be advanced over coronal post 120 of the the impression coping 100. As seen best in FIGS. 8-10 (FIG. 8 being an apical end view of FIG. 7; FIG. 9 being a cross-sectional view taken through line 9-9 in FIG. 8; and FIG. 10 being a cross-sectional view taken through line 10-10 in FIG. 8), provided on the internal peripheral surface of the temporary coping 700 proximate the apical end 780 is a retention feature in the form of a continuous protrusion ring 716 that extends, in the exemplary embodiment of FIGS. 7-10, around the inner peripheral surface of the coping 700 up to a flat surface portion 720. As perhaps best shown in FIGS. 8 and 9, the flat surface portion 720 may extend inwardly relative to the remaining surface of the temporary coping 700. The flat surface portion 720 may present a substantially flat surface facing toward a center of the temporary coping 700, and may be configured to correspond and abut in a substantially flush manner with one of the flat surface portions 122 on the impression coping 100 to help prevent relative rotation of the temporary coping 700 relative to the impression coping and/or to assist in alignment of the temporary coping 700 relative to the impression coping 100. In an alternative exemplary embodiment (not shown), the temporary coping may include a second internal flat surface portion similar to flat surface portion 720 but disposed opposite thereto and configured to mate in a substantially flush manner with the other of the flat surface portions 122 on the impression coping 100.

The protrusion ring 716 may be configured to provide a mating engagement with the retention groove 125 of the impression coping 100, for example to provide a snap-fit engagement between the temporary coping 700 and the impression coping 100. The protrusion ring 716 may have a convex profile and be configured to engage (e.g., in a snap-fit manner) retention groove 125. In other words, the protrusion ring 725 may be configured to mate in a precise and substantially flush manner with the retention groove 125 when the temporary coping 700 is advanced down over and into mating engagement (e.g., snap-fit) with the impression coping 100.

With reference to FIGS. 9 and 10, the interior of the temporary coping 700 may present a surface tapering inward from the apical open end 780 toward the coronal end 790. The degree of taper may substantially correspond to the taper of the coronal post 120 of the impression coping 100. For example, the angle of taper, θ, may range from about 4° to about 8°, for example, from about 5° to about 6.5°, for example, θ may be about 6°.

The various dimensions, including its length, inner and outer lateral surface dimensions, wall thickness, etc., of the temporary coping 700 may be selected as desired based on the implant and impression coping dimensions. For example, the diameter D_{TC} (see FIG. 10) may be sized so as to substantially correspond to diameter D_{A} of the impression coping 100 to provide a flush mating finish line between those two components, as depicted in FIG. 12, for example. In various exemplary embodiments, D_{TC} may range from about 2.5 mm (0.098 in.) to about 7 mm (0.276 in.), for example, from about 3 mm (0.118 in.) to about 6.5 mm (0.256 in.).

The temporary coping 700 may include a cuff 785 at the apical end 780 to permit patient-specific contouring of the temporary restoration to occur based on the gingival tissue height of the patient, as those having ordinary skill in the art are familiar with. The cuff 785 may have an angled outer surface, which may be disposed, for example, at an angle δ ranging from about 45° to about 75°, for example about 60°, from horizontal in the orientation of FIG. 10. The height of the cuff h_{TC, cuff} (see FIG. 10) may range from about 1 mm (0.039 in.) to about 4 mm (0.157 in.), and the overall length (including the cuff 785) from the apical end 780 to the coronal end 790 may range from about 4 mm (0.157 in.) to about 9 mm (0.354 in.). In various exemplary embodiments, the thickness t_{TC} of the walls of the temporary coping 700, except at the location of the flat surface portion 720, may range from about 0.02 in. to about 0.06 in., for example about 0.04 in.

The angled surfaces of end 780 of temporary coping 700, e.g., on the cuff 785, may facilitate moving tissue out of the way if needed during engagement of the temporary coping 700 with the impression coping 100.

Although the exemplary embodiment of FIGS. 7-10 shows a temporary coping provided with a single continuous protrusion ring extending approximately 270° around an inner peripheral surface of the temporary coping (i.e., around the inner peripheral surface with the exception of flat surface portion 720), in an alternate exemplary embodiment, as depicted in the apical end view of FIG. 11, a temporary coping 1700 may be provided with one or more relatively localized protrusions 1716 configured to engage, e.g., in a snap-fit manner, with one or more retention grooves or localized indentations on an impression coping in accordance with the present teachings. The temporary coping 1700 may include two protrusions 1716 disposed substantially opposite one another with the internal flat surface portion 1720 being disposed substantially midway between the two protrusions 1716. Other portions of the temporary coping 1700 may be substantially the same as those described above with reference to temporary coping 700. In yet another alternative exemplary embodiment (not shown), rather than a single protrusion ring, a temporary coping in accordance with the present teachings may be provided with protrusion ring of a different angular extent than that shown in FIGS. 7-10 or with a plurality of protrusion rings spaced from each other around the internal peripheral surface at substantially the same axial position of the temporary coping. Those having ordinary skill in the art would recognize various modifications to the protrusion features that could be made without departing from the scope of the present teachings. As used herein, when referring to a “protrusion ring,” it should be understood that such terminology is intended to cover partial (e.g., arc-shape) protrusion structures. The term protrusion ring is not limited to protrusion features that extend around an entire inner peripheral surface (such as, for example, 360°), but can include continuous protrusions that have various lengths (or angular extent around the circumference).

The configuration (e.g., size and shape) of the protrusion features, whether in the form of one or more protrusion rings or one or more relatively localized protrusions, may be chosen based on the various considerations, such as, for example, the shape and size of one or more retention grooves with which the protrusion features are designed to engage, the desired force required to achieve a mating engagement, e.g., snap-fit engagement, between the protrusion features and the retention grooves, and/or the retention force (or pull-off force) desired between the impression coping and temporary coping. Likewise, the number and positioning of the protrusion features, whether in the form of protrusion rings or relatively localized protrusions, may vary and may be selected based on similar considerations; the number of protrusion features on the temporary coping may range from one to more than one.

In various exemplary embodiments, the protrusion features, whether in the form of a continuous ring and/or localized protrusions, may have a substantially convex profile with a radius of curvature ranging from about 0.015 in. to about 0.025 in., for example, about 0.02 in., and may protrude from the internal peripheral surface portion of the coping from about 0.002 in. to about 0.006 in., for example, about 0.004 in. The height of the protrusion features (e.g., as measured along the longitudinal axis direction of the temporary coping) may range from about 0.015 in. to about 0.040 in., for example about 0.021 in. Of course, those having ordinary skill in the art would understand that these dimensions are exemplary only and may vary depending on, for example, the dimensions of a retention groove with which the protrusion features are designed to engage in a snap-fit manner, the desired retention force between the protrusion features and such a retention groove, etc.

By way of example, the one or more protrusion features on a temporary coping in accordance with various exemplary embodiments may be configured so as to provide substantially a 100% interference mating fit with one or more corresponding retention grooves on an impression coping with which the one or more protrusion features are desired to engage. By way of further example, the one or more protrusion features on a temporary coping may be configured so as to be placed into mating engagement, for example, via snap-fit, with one or more retention grooves by utilizing a force ranging from about 2.5 lb. to about 7 lb. In addition, the one or more protrusion features on a temporary coping may be configured so as to provide a force ranging from about 10 lb. to about 20 lb., for example, about 15 lb., to disengage the protrusions from one or more retention grooves on an impression coping (i.e., pull off the temporary coping from the impression coping).

Although in the exemplary embodiment illustrated in FIGS. 7-11, the retention protrusions have a substantially convex radiused surface profile, such a surface profile configuration is exemplary only and the protrusions could have a variety of configurations such as angled with two or more sides so as to engage a variety of different retention groove surface profiles, including, for example, triangular-, square-, rectangular-, and other polygonal-shaped protrusion surface profiles. Moreover, as described above with respect to the impression coping, it is considered within the scope of the present teachings that the one or more retention features provided on the impression coping can be in the form of protrusions and those on the temporary coping can be in the form of indentations (e.g., grooves) or each of the impression coping and the temporary coping could have a mix of such retention features configured to matingly engage corresponding features on the other of the impression coping and the temporary coping.

In another exemplary embodiment (not shown), a temporary coping may be substantially the same as the temporary coping 700 or 1700 with the exception of not being provided with a flat surface portion 720, 1720. In the case of such a temporary coping, the protrusion ring may extend around the entire internal peripheral surface of the temporary coping. Such a temporary coping without the flat surface portion 720 (often referred to as a “round” temporary coping, whereas a temporary coping with the flat surface portion is often referred to as a “flat” temporary coping) is typically used when multiple restorations are required in a patient's mouth. Those ordinarily skilled in the art are familiar with the use of a pair of so called “round” temporary copings used in the context of multiple restorations.

FIG. 12 shows a temporary restoration 1200 comprising the temporary coping 700 of FIGS. 7-10 and the outer aesthetic tooth portion (e.g., the veneer) 1205 in snap-fit engagement with the impression coping 100. The temporary coping 700 is shown in cross-section to provide a better view of its engagement with the impression coping 100. As illustrated, the protrusion ring 716 mates with the retention groove 125 in a substantially flush manner to secure the temporary restoration 1200 to the impression coping 100, with a finish line of the temporary restoration 1200 being provided on the impression coping 100.

In various exemplary embodiments, temporary copings in accordance with the present teachings may be made of a plastic material that relatively easily permits mating engagement (e.g., via snap-fit engagement) of one or more protrusion features with one or more retention grooves on an abutment. Examples of suitable materials include, but are not limited to, materials comprising poly-ether-ether ketone (PEEK), hybrid PEEK, PEEK polymer, nylon, poly(methyl-methacrylate) (PMMA), and/or Delrin. Alternatively, temporary copings in accordance with the present teachings may be made of a metal material, such as, for example, various grades of titanium, titanium alloys, and/or stainless steel. Yet another suitable material for temporary copings in accordance with the present teachings may include a hybrid composite material comprising both metal and plastic.

Various exemplary materials, such as, for example, a bis-acrylic material, that permit a chemical bonding of the temporary coping with a veneering material used to form the aesthetic outer tooth portion of the temporary restoration also may be used to form temporary copings in accordance with exemplary embodiments of the present teachings. Such chemical bonding may be used without the need for another bonding mechanism to bond the temporary coping to the temporary replacement tooth veneering material (e.g., acrylic material and/or other material suitable for forming a temporary restoration with which those having ordinary skill in the art have familiarity), although additional bonding mechanisms may be employed. For various materials that may be used to make a temporary coping that achieves such a chemical bonding with the temporary restoration, reference is made to U.S. patent application Ser. No. 12/332,524, filed Dec. 11, 2008, which is incorporated by reference herein in its entirety. One example of a suitable bis-acrylic material that may be used to form a temporary coping in accordance with various exemplary embodiments includes Protemp™ Plus Temporization Material made by 3M ESPE.

In at least one exemplary embodiment, a temporary coping in accordance with the present teachings may be configured to be used to both take the impression (e.g., similar to an impression cap) and to support a temporary restoration (e.g., as a temporary coping). With reference to the exemplary embodiment of FIG. 15, a temporary coping 1500 may comprise an outer surface having one or more surface features configured to provide sufficient embedment in an impression material to register a location of a dental implant when the temporary coping 1500 is in position relative to the implant in the patient's mouth. For example, the temporary coping 1500 may have a configuration configured to engage with the impression coping 100 via a mating retention in a manner similar to that described above with respect to the temporary copings of the exemplary embodiments of FIGS. 7-12, for example, using snap-fit retention features. In various exemplary embodiments, as described further below, the surface features on the outer surface also may be configured to permit the temporary coping 1500 to be picked up in the impression material and removed therewith after the impression his taken (i.e., in a pick-up impression procedure). In an exemplary embodiment, the impression features can include one or more grooves, such as, for example, the horizontal and vertical grooves 1550 illustrated in FIG. 15. The grooves can have sufficient dimensions to permit the impression material to embed therein and cause retention of the coping 1500 such that it can be picked up with the impression material as it is removed from the implant site.

Thus, unlike the temporary copings described above with reference to other exemplary embodiments, the temporary coping 1500 may be configured to permit the temporary coping to be placed in a snap-fit engagement with the impression coping (or an alternative abutment structure) and exhibit a pull-off force that permits the temporary coping, after embedment in impression material, to be picked up with the impression off of the impression coping 100 and away from the implant site (e.g., out of the patient's mouth). In this manner, the temporary coping 1500 can be used in an impression procedure (e.g., a pick-up impression procedure), used to create a temporary and/or permanent restoration (e.g., in the lab or chairside) in a variety of manners known to those ordinarily skilled in the art, and then reengaged with the impression coping 100 an implant as a support for the temporary restoration. To permit the temporary coping 1500 to be used in a pick-up impression procedure, in various exemplary embodiments, the pull-off force of the temporary coping 1500 from the impression coping 100 may range from about 0.5 lbs to about 6 lbs, for example, from about 1.5 lbs to about 2.5 lbs. In an alternative embodiment, the temporary coping 1500 could be configured for use in a transfer type of impression procedure as well.

Various other components of the temporary copings 1500 (e.g. protrusion features, tapered internal surface, flats, cuffs, etc.) may be as described above with respect to other exemplary embodiments of temporary copings. Those ordinarily skilled in the art would understand that the number, size and arrangement of the surface features (e.g., grooves 1550) may be altered as desired without departing from the scope of the present teachings and may be selected so as to achieve sufficient embedment to permit a pick-up impression of the temporary coping. For example, the impression features could include any number of horizontal grooves only, vertical grooves only, or a combination of horizontal and vertical grooves. Those ordinarily skilled in the art would also understand that the impression features can be in a variety of forms and need not be only grooves, but rather could include other surface features, such as, for example, knurled surface portions, roughened surface portions, dimples, ridges, etc., without departing from the scope of the present teachings and claims.

In some exemplary embodiments, it may be desirable to use a temporary cement or other type of bondable material in addition to a snap-fit retention of the temporary coping 1500 relative to the impression coping 100. Further, those having ordinary skill in the art would recognize that the temporary coping 1500 could be secured, for example, in a snap-fit manner, relative to an abutment secured to a dental implant, rather than the impression coping 100, during both the impression procedure and when used to support the temporary restoration at the implant site.

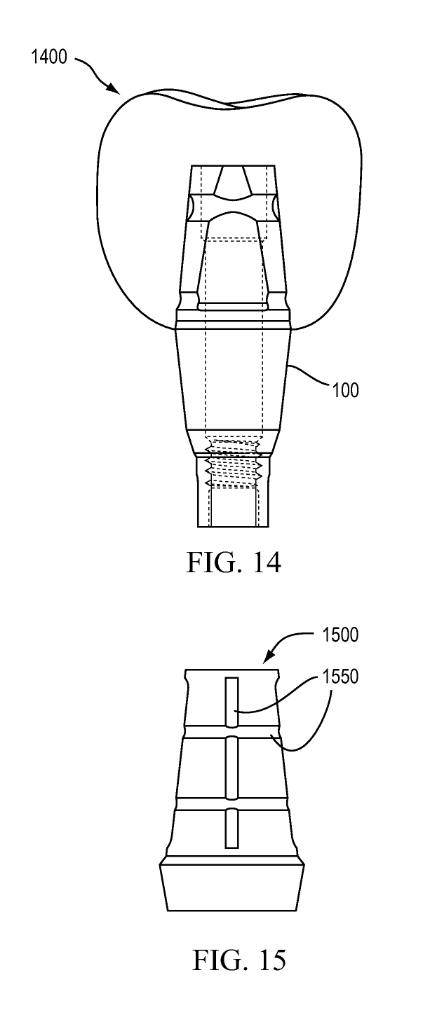

Aside from supporting a temporary restoration that includes a temporary coping, as depicted and described for example with reference to FIGS. 7-12, impression copings in accordance with the present disclosure can be reused as a support structure to support a temporary restoration comprising a hardenable malleable preform that is placed in direct contact with the impression coping. Such preforms may comprise a hardenable or curable material that is malleable and self-supporting at room temperature and may be cured by heat or light, for example, ultraviolet light. For example, the hardenable malleable preform can be placed over impression coping 100 and molded and shaped as desired around the impression coping 100, and then hardened to form the temporary restoration. FIG. 14 illustrates an exemplary embodiment of a temporary restoration 1400 that does not include a temporary coping substructure, but rather is a hardenable malleable preform and is secured directly to the impression coping, which in turn is secured to the implant. In an exemplary embodiment, the hardenable malleable preform may be a structure sold by 3M under the name PROTEMP™ CROWN. For further details regarding hardenable malleable preforms that may be used as a temporary restoration supported by impression copings in accordance with exemplary embodiments herein, reference is made to U.S. application Ser. No. 12/508,262, filed Jul. 23, 2009, the entire contents of which are incorporated by reference herein.

As mentioned above, exemplary embodiments of impression copings in accordance with the present teachings are configured to be used to take an impression of a location and position of an implant, such as, for example, a dental implant, and also to support a prostheses, such as, for example, a temporary restoration, relative to the implant. One exemplary method for using the impression coping 100 will now be described.

After a dental implant, such as, for example, the dental implant 1300 shown in FIG. 13, is implanted in a patient's mouth at the desired site, the impression coping 100 may be secured to the dental implant 1300, for example, using screw 500. The impression coping 100 may be secured to the dental implant 1300 immediately or closely following implantation of the implant, or after a period of time after implantation to allow for at least some setting of the implant. Once the impression coping 100 is secured in place, impression material may be formed around the impression coping 100 and the neighboring teeth and gumline, in a manner known to those ordinarily skilled in the art. In an exemplary technique, a closed tray technique may be used to take the impression. In such a technique, once the coronal post 120 of the impression coping 100 has been sufficiently embedded in the impression material and the impression material allowed to at least partially harden, the impression may be lifted away from the patient's mouth leaving the impression coping 100 behind in secure position on the implant 1300. The impression coping 100 may then be removed from the implant 1300 and patient's mouth by loosening and removing the screw 500. Those ordinarily skilled in the art will appreciate that in an alternative exemplary embodiment, instead of using a closed-tray impression technique, an open-tray impression technique could be used. Also, the impression coping may be configured to permit a pick-up impression technique.

At this stage, the impression coping 100 can be reinserted in the impression and the impression and impression coping 100 taken to fabricate the mold for a permanent restoration, for example, at a dental laboratory. After use for making the mold for the permanent restoration, the impression coping 100 may be reused as a support for a temporary restoration in the patient's mouth. That is, instead of throwing away the impression coping 100 or reusing it again only for taking another impression, the impression coping 100 can serve as an abutment by re-securing it to the dental implant 1300 in the patient's mouth using the screw 500. Once it is secured to the implant, a temporary restoration, such as, for example, the temporary restoration 1200 of FIG. 12 may be secured to the impression coping 100. For example, the coping 700 of FIG. 12 may be snap-fit to the impression coping 100 by engagement of retention features 716 and 125, as described above. The temporary restoration may be formed in a dental laboratory or chairside by the dentist; those having ordinary skill in the art are familiar with various techniques for forming temporary restorations.

Alternatively, a hardenable malleable preform may be placed directly over and in contact with the impression coping 100, molded as desired into shape (e.g., by hand or with a shaping tool), and then hardened to form a temporary restoration, such as, for example, the temporary restoration 1400 of FIG. 14. In an exemplary embodiment, the hardenable malleable preform may have a pre-hardened inner surface with one or more retention features (e.g., one o r more protrusions or grooves) configured to snap-fit to the retention feature on the impression coping 100. After snap-fitting the hardenable malleable preform with a pre-hardened inner surface to the impression coping coronal post 120, the preform may be molded into a desired shape, and hardened to form the temporary restoration 1400. Reference is made to U.S. application Ser. No. 12/508,262, incorporated by reference herein, for further details regarding partially-hardened malleable preforms that can be used to snap-fit to the impression coping 100.

In various exemplary embodiments, depending on the material used for the impression coping, it may be possible to form a chemical bond between the temporary restoration and the impression coping. For example, for an impression coping made of a bis-acrylic material, it may be possible to chemically bond either a temporary coping made of a bis-acrylic material or the hardenable, malleable preform to the impression coping. Reference is made to U.S. application Ser. No. 12/332,524, incorporated by reference herein, for further details regarding the ability to form a chemical bond between a component prosthetic/implant parts made of bis-acrylic and/or other chemically bondable materials.

In an exemplary embodiment, after the permanent restoration has been made and is ready to be secured relative to the implant, the temporary restoration 1200 or 1400 and the impression coping 100 may be removed from the patient's mouth and a permanent abutment and permanent restoration secured to the dental implant. In at least one exemplary embodiment, the temporary restoration 1200 or 1400 may be pulled with sufficient force to overcome the snap-fit retention of the temporary restoration to the impression coping 100. In another exemplary embodiment, the temporary restoration may be drilled so as to provide access to the screw 500 to loosen the screw and remove the entire assembly of the impression coping, screw and temporary restoration from the implant and the patient's mouth.

Various exemplary embodiments of the present teachings therefore, provide impression copings and/or temporary copings that can serve multiple purposes, including taking an impression and serving as a support structure by which to support a temporary prosthesis, such as a temporary tooth restoration, on an implant, such as a dental implant. Providing mating snap-fit retention features on the impression coping and a temporary restoration (e.g. whether including a temporary coping or not) enables a relatively simple, yet sufficiently strong mechanism by which to secure the temporary restoration to the impression coping. Also, in various exemplary embodiments, use of a material, such as a bis-acrylic material, for the temporary coping that is chemically bondable to the veneering material that forms the outer aesthetic tooth portion of the temporary restoration can produce a temporary restoration that is sufficiently strong under occlusal loading and also relatively simple to fabricate. And in various exemplary embodiments, making the impression coping from a metal, such as, for example, titanium, titanium alloy, and/or stainless steel, may provide a sufficiently strong impression coping that can withstand occlusal loads during support of a temporary restoration while also permitting observation of the impression coping on X-ray, which can be desirable when taking an impression.

Using the copings and impression techniques according to exemplary embodiments of the present teachings may save both money and time involved with the placement of temporary restorations for dental implant procedures. The same part can be used and sent to the laboratory to make the model for the temporary restoration and/or the permanent restoration, and then sent back for securing to the implant to support the temporary restoration. The configuration of impression copings in accordance with various exemplary embodiments also may avoid the need to cement temporary copings and thereby avoid the risk of getting cement below the patient's gums.

It will be appreciated by those ordinarily skilled in the art having the benefit of this disclosure that the present teachings provide various exemplary devices, systems, and methods for taking impressions of implants and securing prosthetic structures thereto. Further modifications and alternative embodiments of various aspects of the present teachings will be apparent to those skilled in the art in view of the description herein. Accordingly, this description is to be construed as illustrative only and is for the purpose of teaching those skilled in the art the general manner of carrying out the present teachings.

It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one ordinarily skilled in the art after having the benefit of the description herein. Changes may be made in the elements described herein without departing from the spirit and scope of the present teachings and following claims. By way of example, dimensions of the impression copings, temporary copings, and/or dental implants described herein may be altered as desired for particular applications. Further, the configuration of the implants and the impression coping's implant-connecting portions shown and described in the illustrated embodiments is non-limiting and exemplary only and those having ordinary skill in the art will appreciate that modifications to the impression coping can be made to use the impression coping with other implant configurations. To that end, it is envisioned that the impression copings and temporary restorations in accordance with the present teachings may be configured to be secured to a variety of implant designs, including submerged implants, bone-level implants, and tissue level implants, both single- and two-stage. Also, although various exemplary embodiments describe components and techniques used for temporary dental prostheses, those of ordinary skill in the art would appreciate that exemplary embodiments of the present teachings can be configured to apply to a variety of types of prostheses placed relative to implants in bone and/or cartilage, including but not limited to, for example, extra-oral (e.g., prostheses for eyes, ears, or noses) and/or orthopedic implants. Further, those ordinarily skilled in the art would understand that the type of mating retention features on components of the exemplary embodiments shown and described herein could be reversed on the components and thus those components having with one or more grooves or indentations could instead have one or more protrusions, and those components having with one or more protrusions could instead have one or more grooves or indentations. Moreover, the protrusion features in various exemplary embodiments illustrated, whether localized or in the form of protrusion rings, have generally radial profiles (e.g., semi-spherical), but those having ordinary skill in the art that would understand that those features could have various shapes and configurations, including but not limited to, for example, rectangular, cubical, pyramidal, etc. without departing from the scope of the present teachings. In addition, retention grooves could have a variety of shapes, including, but not limited to, for example, notch-shaped (e.g., V-shaped), or presenting multiple sides.

Those having ordinary skill in the art would understand that features, components, steps, and/or materials described with respect to a particular exemplary embodiment set forth herein may be used with one or more other exemplary embodiments set forth herein and modifications made accordingly. It is to be understood that the particular examples and embodiments set forth herein are nonlimiting, and modifications to structure, dimensions, materials, and methodologies may be made without departing from the scope of the present teachings.

Other embodiments of the present teachings will be apparent to those skilled in the art from consideration of the specification and practice of the present teachings disclosed herein. It is intended that the specification and examples be considered as exemplary only, with the claims being provided a scope of a breadth supported by the present teachings and including equivalents.

What is claimed is:

1. An impression coping, comprising:
an implant-engaging portion configured for engagement with a dental implant; and
a coronal post comprising
at least one impression feature having dimensions to permit embedment in impression material, and
at least one retention feature configured to matingly engage a corresponding retention feature of a temporary restoration to secure the temporary restoration to the impression coping.

2. The impression coping of claim 1, wherein the at least one retention feature of the coronal post is configured for snap-fit engagement with the at least one retention feature on a temporary restoration.

3. The impression coping of claim 1, wherein the at least one retention feature on the coronal post is chosen from a recess and a protrusion.

4. The impression coping of claim 3, wherein the recess is chosen from a groove and a localized indentation and wherein the protrusion is chosen from a protrusion ring and a localized protrusion.

5. The impression coping of claim 1, wherein the impression coping is made from a radiopaque material.

6. The impression coping of claim 5, wherein the impression coping is made from a material chosen from titanium, titanium alloy, stainless steel, or a combination thereof.

7. The impression coping of claim 1, wherein the coronal post further comprises at least one flat surface portion extending axially along the coronal post.

8. The impression coping of claim 1, wherein the coronal post is tapered.

9. The impression coping of claim 1, further comprising a frustro-conical portion disposed between the coronal post and the apical post.

10. The impression coping of claim 1, wherein the impression coping is configured to be screw-retained to a dental implant.

11. The impression coping of claim 1, wherein the impression coping has a surface providing a finish line for a temporary restoration secured to the coronal post.

12. The impression coping of claim 1, wherein the implant-engaging portion comprises a post configured to be inserted into a coronal seat of a dental implant.

13. A dental restoration system, the system comprising:
an impression coping configured for engagement with a dental implant, the impression coping comprising
at least one impression feature configured for embedding in impression material, and
at least one retention feature; and
a temporary restoration comprising at least one retention feature configured to matingly engage with the at least one retention feature on the impression coping to secure the temporary restoration to the impression coping.

14. The system of claim 13, wherein the temporary restoration comprises a temporary coping and an outer veneer material surrounding the temporary coping.

15. The system of claim 14, wherein the at least one retention feature of the temporary restoration is disposed on an internal surface of the temporary coping.

16. The system of claim 14, wherein the temporary coping and the outer veneer material are configured to chemically bond to each other.

17. The system of claim 14, wherein the temporary coping is made of a bis-acrylic material.

18. The system of claim 13, wherein the at least one retention feature of the temporary restoration and the at least one retention feature of the impression coping are configured for snap-fit engagement with one another.

19. The system of claim 13, wherein the impression coping comprises a radiopaque material.

20. The system of claim 13, wherein the temporary restoration comprises a hardenable malleable preform.

21. A method of performing a dental restoration, the method comprising:
securing to a dental implant an impression coping that has been previously used to take an impression of the dental implant; and
then securing a temporary restoration to the impression coping.

22. The method of claim 21, wherein securing the temporary restoration to the impression coping comprises engaging mating retention features on a temporary coping of the temporary restoration and the impression coping with one another.

23. The method of claim 22, wherein engaging the mating retention features comprises snap-fitting the mating retention features to one another.

24. The method of claim 21, wherein securing a temporary restoration to the impression coping comprises placing a hardenable malleable temporary restoration preform in contact with the impression coping and hardening the preform.

25. A method of performing a temporary dental restoration, the method comprising:
securing a component comprising at least one impression feature to a dental implant implanted in a patient's mouth;
embedding a portion of the component comprising the at least one impression feature in impression material to take an impression;
removing the impression and the component from the patient's mouth;
re-securing the component relative to the dental implant to support a temporary restoration relative to the dental implant.

26. The method of claim 25, wherein the component is chosen from an impression coping and a temporary coping.

27. The method of claim 25, wherein the component supports a temporary restoration veneering material relative to the dental implant.

28. The method of claim 25, further comprising securing to the component a temporary coping of the temporary restoration.

29. A temporary coping comprising:
an inner surface comprising at least one retention feature configured to matingly engage with at least one corresponding retention feature of a support secured to an implant; and
an outer surface comprising at least one impression feature configured for embedding in impression material,
wherein the temporary coping is configured to be removed from mating engagement with the support under a pull-off force ranging from about 0.5 lb. to about 6 lb.

30. The temporary coping of claim 29, wherein the at least one impression feature comprises at least one groove.

31. The temporary coping of claim 29, wherein the at least one retention feature comprises at least one protrusion feature.
